(19) United States
(12) Patent Application Publication
(10) Pub. No.: US 2019/0168297 A1
(43) Pub. Date: Jun. 6, 2019

(54) EMBEDDING PARTICLES IN A DESIRED COMPONENT

(71) Applicant: MICROCVD CORPORATION, Dayton, OH (US)

(72) Inventor: Zhigang Xiao, Dayton, OH (US)

(21) Appl. No.: 16/204,200

(22) Filed: Nov. 29, 2018

Related U.S. Application Data
(60) Provisional application No. 62/593,301, filed on Dec. 1, 2017.

(51) Int. Cl. B22F 1/00; B29C 64/153; B22F 3/105; B29C 64/209

(52) U.S. Cl. CPC B22F 1/0018; B29C 64/153; B33Y 10/00; B29C 64/209; B22F 3/1055

(57) ABSTRACT

A process for printing a desired component with embedded nanoparticles is disclosed and comprises maintaining a separation of a structure material from precursor materials. Then, flow of the structure material is regulated to a printing area and used to create a first layer of the desired component. Further, flow of the precursor materials is regulated to a surface of the first layer of the desired component, which is heated to produce a nanoparticle from the precursor material. Then, a second layer of the desired component is created from the structure material, and flow of the precursor materials is regulated to a surface of the second layer of the desired component, which is heated to produce another nanoparticle from the precursor material.

### CROSS REFERENCE TO RELATED APPLICATIONS

This application claims the benefit of U.S. Provisional Patent Application Ser. No. 62/593,301, filed Dec. 1, 2017, entitled EMBEDDING NANOPARTICLES IN A DESIRED COMPONENT, the disclosure of which is hereby incorporated by reference.

### BACKGROUND

Various aspects of the present invention relate generally to embedding nanoparticles in a desired component and specifically to using additive manufacturing to embed nanoparticles into the desired component.

A nanoparticle is a tiny particle surrounded by an interfacial layer. Further, a nanoparticle behaves as a whole unit with respect to its transport and properties. Some nanoparticles are created by heating precursor materials (directly or indirectly), and in most cases more than one precursor material are required to produce one type of nanoparticle. For example, a tungsten (W) nanoparticle can be created if tungsten fluoride (WF₆) with hydrogen (H2) gas are presented on a surface heated to 600-1000 degrees Celsius. As another example, a silicon (Si) nanoparticle may be produced through a chemical reaction of Silane (SiH4) heated to 400-600 degrees Celsius.

### BRIEF SUMMARY

According to aspects of the present disclosure, a process for printing a desired component with embedded nanoparticles is disclosed and comprises maintaining a separation of a structure material from precursor materials. Then, flow of the structure material is regulated to a printing area and used to create a first layer of the desired component. Further, flow of the precursor materials is regulated to a surface of the first layer of the desired component, which is heated to produce a nanoparticle (usually many nanoparticles) from the precursor material. Then, a second layer of the desired component is created from the structure material, and flow of the precursor materials is regulated to a surface of the second layer of the desired component, which is heated to produce another nanoparticle from the precursor material.

According to further aspects of the present disclosure, printhead for embedding a nanoparticle in situ during construction of a desired component comprises a substrate and an aperture within the substrate. A first precursor microchannel couples to the substrate and extends radially from the first aperture. Further, a first vacuum microchannel couples to the substrate and extends radially from the first aperture in line and opposite of the first precursor microchannel. Moreover, a second precursor microchannel couples to the substrate and a second vacuum channel couples to the substrate and in line with the second precursor microchannel.

According to still further aspects of the present disclosure, an additive manufacturing machine is disclosed that uses a printhead disclosed herein to embed a nanoparticle in situ during construction of a desired component according to processes described herein.

### BRIEF DESCRIPTION OF THE SEVERAL VIEWS OF THE DRAWINGS

FIG. 1 is a flow chart illustrating a process for embedding a nanoparticle in a desired component, according to various aspects of the present disclosure;

FIG. 2 is a diagram illustrating a first embodiment of a printhead for embedding a nanoparticle in a desired component using additive manufacturing, according to various aspects of the present disclosure;

FIG. 3 is a diagram illustrating a second embodiment of a printhead for embedding a nanoparticle in a desired component using additive manufacturing, according to various aspects of the present disclosure; and

FIG. 4 is a diagram illustrating an additive manufacturing machine for embedding a nanoparticle in a desired component, according to various aspects of the present disclosure.

The figures are not necessarily drawn to scale.

### DETAILED DESCRIPTION

Nanoparticles are embedded in situ in a desired component by printing (e.g., generated through a chemical vapor deposition method) the nanoparticles onto surfaces of layers of the desired component while the desired component is being built. Specifically, an additive manufacturing machine builds a layer of the desired component in any manner that the additive manufacturing machine is programmed to do (e.g., powder bed fusion, material jetting, binder jetting, stereolithography, etc.). Once the layer is created (or while the layer is being created in some additive manufacturing technologies), precursor materials (usually in a gaseous form) are heated by the layer at a specific point by a laser, and the precursors form into nanoparticles (through a chemical reaction) on the layer. For example, the laser heats the layer, which in turn heats the precursor materials (e.g., chemical gases). The additive manufacturing machine then creates subsequent layers with or without adding nanoparticles to those layers.

As described herein the processes and printheads are described for embedding nanoparticles in situ in a desired component. However, the same processes and printheads may be used for larger particles (e.g., microparticles).

Process for Embedding a Nanoparticle In Situ in a Desired Component

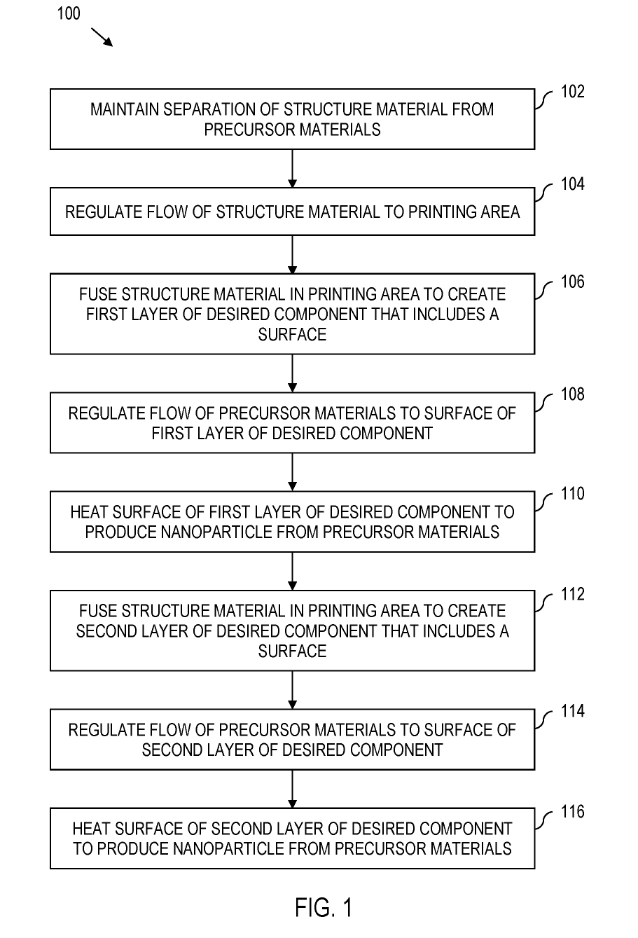

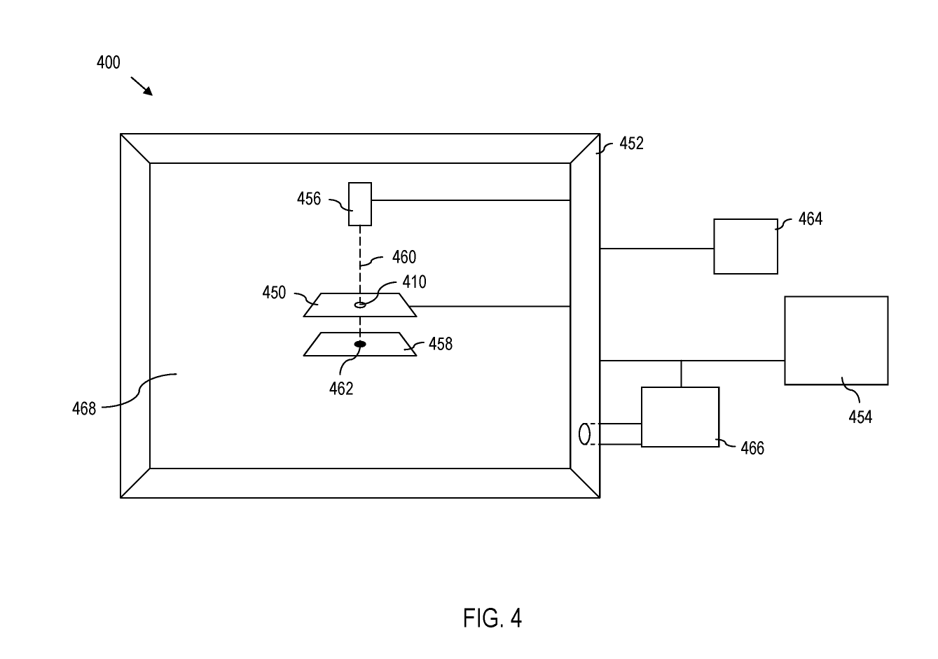

FIG. 1 is a flow chart illustrating a process 100 for embedding nanoparticles in situ in a desired component. While not required, the entire process 100 may take place in an additive manufacturing machine, as discussed below in reference to FIG. 4. At 102, a structure material is maintained separate from precursor materials. The structure material is one or more materials that are used to create a structure for the desired component. For example, in a powder bed fusion machine, the structure material may be powder metal, polymer, powder ceramic, etc. In a stereolithography machine, the structure material may be a resin. Other additive manufacturing machines may have similar or different structure materials.

The precursor materials are materials used to create a nanoparticle when heated. In some embodiments, the precursor materials are a set of precursor materials than when combined and heated result in a type of nanoparticle. For example, if Silane (SiH4) is heated to 400-600 degrees Celsius, then a silicon (Si) nanoparticle is created. As another example, if tungsten fluoride (WF₆) with hydrogen (H2) gas are presented on a surface heated to 600-1000 degrees Celsius, then tungsten nanoparticles are created. Also, in various embodiments, more than one (e.g., two) different sets of precursors may be used to create two different types of nanoparticles on the same layer or different layers of the desired component. In other embodiments, the precursor materials are only one precursor material.

As mentioned above, the precursor materials are kept separate from the structure materials. In other words, the precursor materials are not mixed with the structure materials before any layers of the desired component are created. For example, in a powder bed fusion machine that using two precursor materials (e.g., a first precursor material and a second precursor material) to create one type of nanoparticle, powder metals (i.e., the structure materials) are kept on a plate within a storage area of the powder bed fusion machine. At the same time, the first precursor of the set of precursor materials is kept in its own separate storage container, and the second precursor material is kept in its own separate container.

At 104, flow of the structure material is regulated to a printing area. For example, in a powder bed fusion machine, a wiper may take a layer of the structure material from the storage area and place the structure material in the printing area. As another example, in a stereolithography machine that uses a vat of resin, the flow of resin to the vat may be regulated to zero, because the structure material is already there (the printing area being the top layer of the resin in a vat-based machine). As a further example, in a material jetting machine, the flow of the structure material may be regulated through jetting nozzles of the machine. Basically, regulating flow of the structure material to the printing area just sets up the structure material for creating a layer of the desired component.

At 106, a first layer of the desired component is created in the printing area from the structure material, and the first layer includes a surface. Basically, a layer of the desired component is made as an initial layer or any other layer of the desired component. The way this layer is created will depend on the type of additive manufacturing machine. For example, in a powder bed fusion machine, the first layer is created by fusing together particles of the structure material.

At 108, flow of the precursor materials is regulated to the first layer of the desired component. For example, if the precursor materials are a set of two precursor materials, then flow of the first precursor material is regulated to the first layer of the desired component. Also, flow of the second precursor material is regulated to the first layer of the desired component. Thus, the precursor materials are placed in proximity of the desired component as the desired component is being built.

At 110, the surface of the first layer of the desired component is heated, which in turn heats the precursor materials to create a nanoparticle on the first layer itself. In cases where there are two sets of precursor materials, either set of precursor materials may be used to create the nanoparticle. For example, at one portion of the first layer, a first set of precursor materials may be used to create a first type of nanoparticle on a portion of the surface of the first layer. Then, the second set of precursors may be used to create a nanoparticle of a second type elsewhere on the surface of the first layer. As another example, more than one nanoparticle of a same type may be created on the first layer of the desired component. When creating the nanoparticles on different portions of the same surface, the different portions may be heated individually if desired.

In most embodiments, the surface of the first layer is heated using a laser source. This laser source may be the same laser source that helped create the first layer (if the additive manufacturing machine uses a laser to create the first layer), or the laser source may be a laser that is independent of the laser source that helped create the first layer. If the same laser source is used to create the layer and the nanoparticle, then there should be controls associated with the laser source to adjust the power emitted from the laser source. The heat generated by the laser source is based on the power emitted through laser light from the laser source.

Further, the laser source that creates the nanoparticles (regardless of whether it is the same as the laser source that creates the first layer) should have a control module that adjusts the power emitted by the laser source. When creating a nanoparticle from precursor materials, it is important to heat the precursor materials (via the layer, which is heated by the laser, as discussed herein) to a specific temperature that varies based on the type of nanoparticle to be created. However, a roughness of the surface of the first layer may scatter the laser light as the light hits the surface, which may result in a temperature that is undesirable. As such, the roughness of the surface should be determined (e.g., though inspection of the surface, temperature sensor, etc.) and the power of the laser source may be adjusted based on the determined roughness. For example, if the roughness is determined to be such that the light is scattered such that the temperature produced on the first layer is less than the desired temperature, then the power of the laser may be adjusted such that more power is emitted from the laser source.

While heat from the layer heats the precursor materials, the precursor materials may also be heated directly by the laser as the laser beam passes through the precursor materials to reach the layer. However, such direct heating of the precursor materials by the laser is incidental to the laser beam reaching the layer for heating.

At 112, a second layer of the desired component is created in the printing area from the structure material over the first layer, and the second layer also includes a surface. Again, the way this layer is created will depend on the type of additive manufacturing machine. Further, the second layer does not need to be created directly on top of the first layer. For example, the second layer may be created on top of one or more buffer layers that do not include any nanoparticles.

At 114, flow of the precursor materials is regulated to the second layer of the desired component. For example, if the precursor materials are a set of two precursor materials, then flow of the first precursor material is regulated to the second layer of the desired component. Also, flow of the second precursor material is regulated to the second layer of the desired component. Thus, the precursor materials are placed in proximity of the desired component as the desired component is being built.

At 116, similarly to the creation of the nanoparticle on the first layer (at 110 above), the surface of the second layer of the desired component is heated to a desired temperature, which in turn heats the precursor materials to create a nanoparticle on the second layer itself. In cases where there are two sets of precursor materials, either set of precursor materials may be used to create the nanoparticle. For example, at one portion of the second layer, a first set of precursor materials may be used to create a first type of nanoparticle on a portion of the surface of the second layer. Then, the second set of precursors may be used to create a nanoparticle of a second type elsewhere on the surface of the second layer. As another example, more than one nanoparticle of a same type may be created on the first layer of the desired component. Further, the type of nanoparticle created on the first layer may be the same as the type of nanoparticle created on the second layer. Alternatively, the type of nanoparticle created on the first layer may be different than the type of nanoparticle created on the second layer.

Moreover, as mentioned above, the second layer does not need to be directly on top of the first layer. As such, every layer (or even subsequent layers) are not required to have nanoparticles created on it. In cases where there will be no nanoparticle created on a layer, a purge gas may be introduced to remove any lingering precursor materials.

Thus, using the process 100 of FIG. 1, a desired component may be created with nanoparticles embedded within the component itself. One advantage of using the process 100 over other processes (e.g., other processes that require premixing the precursor materials and the structure material) is that the laser source can be used to create the nanoparticles only where desired. Further, the temperature for creating the nanoparticles may be controlled better when the precursor materials are introduced after the layer is created as opposed to premixing the precursor materials and the structure material. Also, much less of the precursor materials need to be used when creating the nanoparticles in situ as opposed to premixing the precursor materials and the structure material, because only the layers with the nanoparticles (and the specific portions thereof) will require the precursor, as opposed to all of the layers.

Printheads for Embedding a Nanoparticle In Situ in a Desired Component

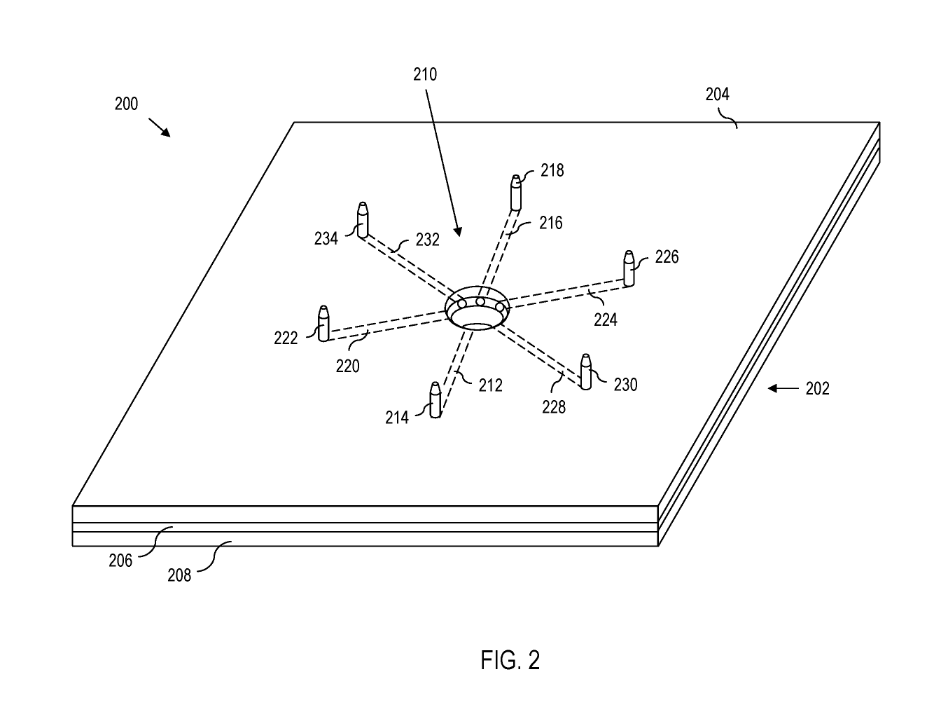

FIG. 2 is a diagram illustrating a first embodiment of a printhead 200 that may be used in the process 100 for creating a desired component with embedded nanoparticles of FIG. 1. The printhead 200 may be a stand-alone printhead of an additive manufacturing machine (such that the additive manufacturing machine has one more printhead than it normally would) or elements described in association with the printhead may be included in the printhead of the additive manufacturing machine (assuming the additive manufacturing machine includes a printhead).

The printhead 200 includes a substrate 202 that may be created from any desired material (e.g., silicon-based, metal, etc.). As shown, the substrate 202 includes three layers: a top layer 204, a photoresist layer 206, and a bottom layer 206. However, the three layers are not required. For example, the substrate 202 may be only one layer (i.e., only one material) or two layers of different materials.

Further, the printhead 200 includes an aperture 210 through which a laser source (see FIG. 4, below) may emit laser light to heat a portion of a layer of a desired component, as discussed in reference FIG. 1, above.

Moreover, the printhead 200 includes a first precursor microchannel 212 that may be coupled to a first precursor material storage unit (not shown) via a first precursor nozzle 214. Thus, the printhead 202 guides the first precursor material to the aperture 210 through the first precursor microchannel 212. To regulate flow of the first precursor material through the first precursor microchannel 212, the first precursor microchannel 212 may include micro-flowmeters, microvalves, or both (not shown).

To aid in the flow of the first precursor through the first precursor microchannel 212 as well as remove any residual precursor material from the nanoparticle creation process 100, FIG. 1, a first vacuum microchannel 216 couples to a vacuum source (not shown) through a first vacuum nozzle 218 to draw in particles (e.g., air, purge gas, precursor materials, etc.) from an area around the aperture 210. Note that the vacuum source may be a vacuum source for the entire additive manufacturing machine or may be an independent vacuum source,

Thus, the first precursor material flows to the aperture 210, where the first precursor material (inter alia) is heated by a laser source (directly, indirectly via a layer, or both—as discussed above) to create a nanoparticle on a layer of the desired component.

Further, the printhead 200 includes a second precursor microchannel 220 that couples to a second precursor material storage unit (not shown) via a second precursor nozzle 222. Thus, the printhead 202 guides the second precursor material to the aperture 210 through the second precursor microchannel 220. As with the first precursor microchannel 212, to regulate flow of the second precursor material through the second precursor microchannel 220, the second precursor microchannel 220 may include micro-flowmeters, microvalves, or both (not shown).

Similar to the first precursor microchannel 212, a second vacuum microchannel 224 couples to the vacuum source (not shown) through a second vacuum nozzle 226 to draw in particles (e.g., air, purge gas, precursor materials, etc.) from the area around the aperture 210.

Also, the printhead 200 includes a purge gas microchannel 228 that couples to a purge gas source (which may be a purge gas source of the additive manufacturing machine or an independent purge gas source) via a purge gas nozzle 230. Of there is a need to purge the printhead 200, purge gas (e.g., argon, nitrogen, helium) flows through the purge gas microchannel 228 and then is removed via a purge vacuum channel 232 coupled to the vacuum source via a purge vacuum nozzle 234.

As mentioned above, in the printhead 200 of FIG. 2, the photoresist layer 206 is between two other layers 204, 208. The photoresist layer 206 may be used to create the six microchannels 212, 216, 220, 224, 228, 232 via photolithography to remove the microchannels from the photoresist layer 206. The microchannels are completed when the photoresist layer 206 is sandwiched between the top layer 204 and the bottom layer 208. Thus, the entire substrate should be non-reactive with the precursor materials or a reaction may occur.

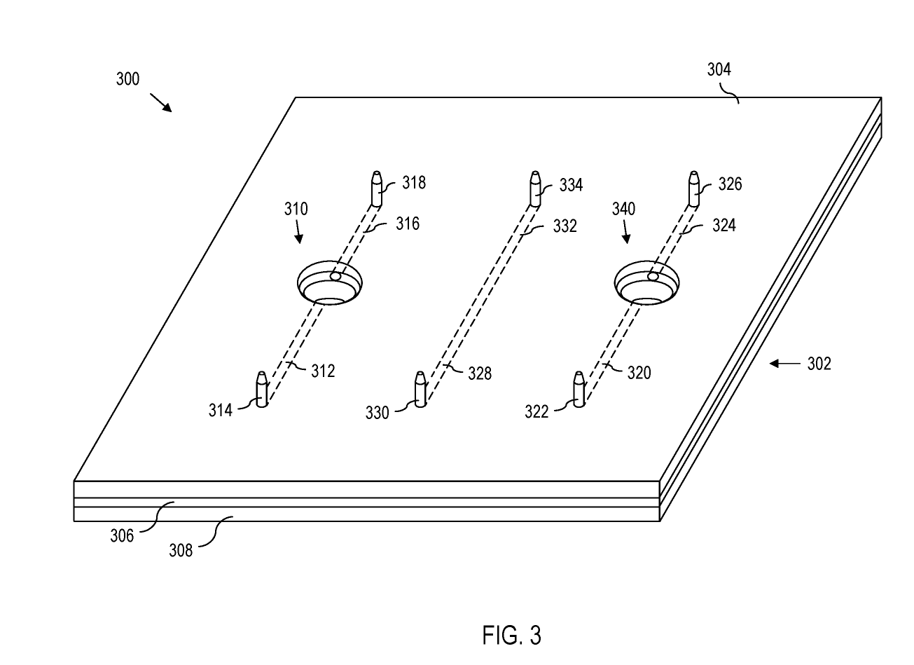

FIG. 3 is a diagram illustrating a second embodiment of a printhead 300 that may be used in the process 100 for creating a desired component with embedded nanoparticles of FIG. 1. As with the printhead 200 of FIG. 2, the printhead 300 of FIG. 3 may be a stand-alone printhead of an additive manufacturing machine (such that the additive manufacturing machine has one more printhead than it normally would) or elements described in association with the printhead may be included in the printhead of the additive manufacturing machine (assuming the additive manufacturing machine includes a printhead).

The printhead 300 includes a substrate 302 that may be created from any desired material (e.g., silicon-based, metal, etc.). As shown, the substrate 302 includes three layers: a top layer 304, a photoresist layer 306, and a bottom layer 306. However, the three layers are not required. For example, the substrate 302 may be only one layer (i.e., only one material) or two layers of different materials.

Further, the printhead 300 includes an aperture 310 through which a laser source (see FIG. 4, below) may emit laser light to heat a portion of a layer of a desired component, as discussed in reference FIG. 1, above.

Moreover, the printhead 300 includes a first precursor microchannel 312 that may be coupled to a first precursor material storage unit (not shown) via a first precursor nozzle 314. Thus, the printhead 300 guides the first precursor material to the aperture 310 through the first precursor microchannel 312. To regulate flow of the first precursor material through the first precursor microchannel 312, the first precursor microchannel 312 may include micro-flowmeters, microvalves, or both (not shown).

To aid in the flow of the first precursor through the first precursor microchannel 312 as well as remove any residual precursor material from the nanoparticle creation process 100, FIG. 1, a first vacuum microchannel 316 couples to a vacuum source (not shown) through a first vacuum nozzle 318 to draw in particles (e.g., air, purge gas, precursor materials, etc.) from an area around the aperture 310. Note that the vacuum source may be a vacuum source for the entire additive manufacturing machine or may be an independent vacuum source.

Thus, the first precursor material flows to the aperture 310, where the first precursor material (inter alia) is heated by a laser source (directly, indirectly, or both) to create a nanoparticle on a layer of the desired component.

Further, the printhead 300 includes a second aperture 340 and a second precursor microchannel 320 that couples to a second precursor material storage unit (not shown) via a second precursor nozzle 322. Thus, the printhead 300 guides the second precursor material to the second aperture 340 through the second precursor microchannel 320. As with the first precursor microchannel 312, to regulate flow of the second precursor material through the second precursor microchannel 320, the second precursor microchannel 320 may include micro-flowmeters, microvalves, or both (not shown).

Similar to the first precursor microchannel 312, a second vacuum microchannel 324 couples to the vacuum source (not shown) through a second vacuum nozzle 326 to draw in particles (e.g., air, purge gas, precursor materials, etc.) from the area around the second aperture 340.

Also, the printhead 300 includes a purge gas microchannel 328 that couples to a purge gas source (which may be a purge gas source of the additive manufacturing machine or an independent purge gas source) via a purge gas nozzle 330. If there is a need to purge the printhead 300, purge gas (e.g., argon, nitrogen, helium) flows through the purge gas microchannel 328 and then is removed via a purge vacuum channel 332 coupled to the vacuum source via a purge vacuum nozzle 334.

As mentioned above, in the printhead 300 of FIG. 3, the photoresist layer 306 is between two other layers 304, 308. The photoresist layer 306 may be used to create the six microchannels 312, 316, 320, 324, 328, 332 via photolithography to remove the microchannels from the photoresist layer 306. The microchannels are completed when the photoresist layer 306 is sandwiched between the top layer 304 and the bottom layer 308. Thus, the entire substrate should be non-reactive with the precursor materials or else a reaction may occur.

Additive Manufacturing Machine

FIG. 4 is a diagram illustrating an additive manufacturing machine 400 for embedding a nanoparticle in a desired component. The additive manufacturing machine includes a printhead 450 similar to one of the embodiments of the printheads (200 of FIG. 2, 300 of FIG. 3) discussed above. Further, the additive manufacturing machine 400 includes a housing 452 and a controller (e.g., hardware, software, processor, combinations thereof, etc.) 454 to control a laser source 456 that is used to create a layer of a desired component 458 from structure materials.

Moreover, the additive manufacturing machine 400 can embed nanoparticles in the desired component 458 by using the laser source 456 (or a different laser, as discussed above) to emit a laser light 460 through an aperture 410 of the printhead 450 to heat a portion 462 of a layer of the desired component 458. In turn, the heated portion 462 of the desired component 458 heats precursor materials placed near the heated portion 462 to create the nanoparticle. The laser source 456 (or different laser) is controlled for this operation by a laser controller 464 that may be separate or part of the additive manufacturing machine controller 454.

Further, the additive manufacturing machine 400 includes a vacuum source 466 that maintains a vacuum in a printing area 468 of the additive manufacturing machine 400. As mentioned above, the printhead 450 may also include a vacuum source that is the same or different from the vacuum source 468 of the additive manufacturing machine 400. Again, the vacuum source 468 may be controlled by the machine controller 454, the laser controller 464, a separate controller altogether, or combinations thereof.

Thus, the additive manufacturing machine 400 of FIG. 4 may be used to implement the process 100 of FIG. 1 to embed nanoparticles in a desired component.

### MISCELLANEOUS

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), Flash memory, an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. A computer storage medium does not include propagating signals.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Network using an Network Service Provider).

Aspects of the present disclosure are described herein with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the invention in the form disclosed. Many modifications and variations will be apparent to those of ordinary skill in the art without departing from the scope and spirit of the invention. Aspects of the disclosure were chosen and described in order to best explain the principles of the invention and the practical application, and to enable others of ordinary skill in the art to understand the invention for various embodiments with various modifications as are suited to the particular use contemplated.

What is claimed is:

1. A process for printing a desired component with embedded nanoparticles, the process comprising:
maintaining a separation of a structure material from precursor materials;
regulating flow of the structure material to a printing area;
creating, from the structure material and in the printing area, a first layer of the desired component, wherein the first layer of the desired component includes a surface;
regulating flow of the precursor materials to the surface of the first layer of the desired component;
heating the surface of the first layer of the desired component to produce a nanoparticle from the precursor material;
creating, from the structure material and in the printing area, a second layer of the desired component over the first layer, wherein the second layer of the desired component includes a surface;
regulating flow of the precursor materials to the surface of the second layer of the desired component; and
heating the surface of the second layer of the desired component to produce a nanoparticle from the precursor material.

2. The process of claim 1, wherein heating the surface of the first layer further comprises:
determining a roughness of the surface of the first layer; and
adjusting a power of a laser to heat the surface of the first layer based on the roughness of the surface.

3. The process of claim 1, wherein:
maintaining a separation of a structure material from precursor materials comprises maintaining a separation of a structure material from a first set of precursor materials to create a first type of nanoparticle and a second set of precursor materials to create a second type of nanoparticle;
regulating flow of the precursor materials to the surface of the first layer of the desired component comprises regulating flow of the first set of precursor materials to the surface of the first layer of the desired component;
heating the surface of the first layer of the desired component to produce a nanoparticle from the precursor material comprises heating the surface of the first layer of the desired component to produce a nanoparticle of the first type of nanoparticle from the first set of precursor materials;
regulating flow of the precursor materials to the surface of the second layer of the desired component comprises regulating flow of the second set of precursor materials to the surface of the second layer of the desired component; and
heating the surface of the second layer of the desired component to produce a nanoparticle from the precursor material comprises heating the surface of the second layer of the desired component to produce a nanoparticle of the second type of nanoparticle from the second set of precursor materials.

4. The process of claim 1, wherein:
maintaining a separation of a structure material from precursor materials comprises maintaining a separation of a structure material from a first set of precursor materials to create a first type of nanoparticle and a second set of precursor materials to create a second type of nanoparticle;
regulating flow of the precursor materials to the surface of the first layer of the desired component comprises:
regulating flow of the first set of precursor materials to the surface of the first layer of the desired component; and
regulating flow of the second set of precursor materials to the surface of the first layer of the desired component; and
heating the surface of the first layer of the desired component to produce a nanoparticle from the precursor material comprises:
heating a first portion of the surface of the first layer of the desired component to produce a nanoparticle of the first type of nanoparticle from the first set of precursor materials; and
heating a second portion of the surface of the first layer of the desired component to produce a nanoparticle of the second type of nanoparticle from the second set of precursor materials.

5. The process of claim 1, wherein:
creating, from the structure material and in the printing area, a first layer of the desired component comprises fusing the structure material in the printing area with a laser to create a first layer of the desired component;
heating the surface of the first layer of the desired component to produce a nanoparticle from the precursor material comprises heating the surface of the first layer of the desired component with the laser to produce a nanoparticle from the precursor material;
creating, from the structure material and in the printing area, a second layer of the desired component comprises fusing the structure material in the printing area with the laser to create a second layer of the desired component; and
heating the surface of the second layer of the desired component to produce a nanoparticle from the precursor material comprises heating the surface of the second layer of the desired component with the laser to produce a nanoparticle from the precursor material.

6. The process of claim 1, wherein:
creating, from the structure material and in the printing area, a first layer of the desired component comprises fusing the structure material in the printing area with a first laser to create a first layer of the desired component;
heating the surface of the first layer of the desired component to produce a nanoparticle from the precursor material comprises heating the surface of the first layer of the desired component with a second laser to produce a nanoparticle from the precursor material;
creating, from the structure material and in the printing area, a second layer of the desired component comprises fusing the structure material in the printing area with the first laser to create a second layer of the desired component; and
heating the surface of the second layer of the desired component to produce a nanoparticle from the precursor material comprises heating the surface of the second layer of the desired component with the second laser to produce a nanoparticle from the precursor material.

7. A printhead comprising:
a substrate;
a first aperture within the substrate;
a first precursor microchannel coupled to the substrate and extending radially from the first aperture;
a first vacuum microchannel coupled to the substrate, wherein the first vacuum microchannel extends radially from the first aperture in line and opposite of the first precursor microchannel;
a second precursor microchannel coupled to the substrate; and
a second vacuum channel coupled to the substrate and in line with the second precursor microchannel.

8. The printhead of claim 7, wherein:
the second precursor microchannel is disposed radially from the first aperture; and
the second vacuum channel is disposed radially from the first aperture and opposite of the first precursor microchannel.

9. The printhead of claim 8 further comprising:
a purge microchannel disposed radially from the first aperture.

10. The printhead of claim 9 further comprising:
a purge vacuum microchannel coupled to the substrate, wherein the purge vacuum microchannel extends radially from the first aperture in line and opposite of the first precursor microchannel.

11. The printhead of claim 10 further comprising:
a second aperture (or aperture) within the substrate;
wherein:
the second precursor microchannel is disposed radially from the second aperture; and
the second vacuum channel is disposed radially from the second aperture and opposite of the first precursor microchannel.

12. The printhead of claim 11 further comprising a purge microchannel.

13. The printhead of claim 12 further comprising a purge vacuum microchannel that extends in line with the purge microchannel.

14. The printhead of claim 7 further comprising:
a first precursor nozzle coupled to the first precursor microchannel opposite from the first aperture; and
a first precursor vacuum nozzle coupled to the first vacuum microchannel opposite from the first aperture.

15. The printhead of claim 7 further comprising a microvalve that controls a flow rate of a precursor gas of the first precursor microchannel.

16. The printhead of claim 7 further comprising a micro flowmeter that senses a flow rate of a precursor gas of the first precursor microchannel.

17. The printhead of claim 7, wherein:
the first precursor microchannel is etched in the substrate;
the first vacuum microchannel is etched in the substrate;
the second precursor microchannel is etched in the substrate; and
the second vacuum microchannel is etched in the substrate.

18. An additive manufacturing machine comprising:
a housing;
a laser source;
a vacuum source;
a vacuum outlet coupled to the housing and the vacuum source; and
a printhead comprising:
a substrate;
a first aperture within the substrate, wherein the laser source is positioned over the aperture;
a first precursor microchannel coupled to the substrate and extending radially from the first aperture;
a first vacuum microchannel coupled to the substrate, wherein:
the first vacuum microchannel extends radially from the first aperture in line and opposite of the first precursor microchannel; and
the first vacuum microchannel is independent of the vacuum outlet;
a second precursor microchannel coupled to the substrate; and
a second vacuum channel coupled to the substrate and in line with the second precursor microchannel, wherein the second vacuum microchannel is independent of the vacuum outlet.

19. The additive manufacturing machine of claim 18, wherein:
the second precursor microchannel is disposed radially from the first aperture;
the second vacuum channel is disposed radially from the first aperture and opposite of the first precursor microchannel; and
the printhead further comprises:
a purge microchannel disposed radially from the first aperture; and
a purge vacuum microchannel coupled to the substrate;
wherein:
the purge vacuum microchannel extends radially from the first aperture in line and opposite of the first precursor microchannel; and
the purge vacuum microchannel is independent of the vacuum outlet.

20. The additive manufacturing machine of claim 18, wherein:
the printhead further comprises a second aperture within the substrate, wherein:
the second precursor microchannel is disposed radially from the second aperture; and
the second vacuum channel is disposed radially from the second aperture and opposite of the first precursor microchannel
a purge microchannel; and
a purge vacuum microchannel coupled to the substrate;
wherein:
the purge vacuum microchannel extends radially from the first aperture in line and opposite of the first precursor microchannel; and
the purge vacuum microchannel is independent of the vacuum outlet.
